(19) United States
(12) Patent Application Publication
(10) Pub. No.: US 2025/0168664 A1
(43) Pub. Date: May 22, 2025

(54) TIME ALIGNMENT TIMER HANDLING IN WIRELESS COMMUNICATIONS

(71) Applicant: LG ELECTRONICS INC., Seoul (KR)

(72) Inventors: Hongsuk KIM, Seoul (KR); Sunghoon JUNG, Seoul (KR); Sunyoung LEE, Seoul (KR)

(73) Assignee: LG ELECTRONICS INC., Seoul (KR)

(21) Appl. No.: 18/834,859

(22) PCT Filed: Feb. 1, 2023
(86) PCT No.: PCT/KR2023/001451

§ 371 Date: Jul. 31, 2024

(30) Foreign Application Priority Data
Feb. 15, 2022 (KR) 10-2022-0019680

(51) Int. Cl. H04W 24/04; H04W 56/00

(52) U.S. Cl. CPC H04W 24/04; H04W 56/001

(57) ABSTRACT

The present disclosure relates to a time alignment timer handling in wireless communications. According to an embodiment of the present disclosure, a user equipment (UE) may initiate a transmission of failure information for a cell group based on detecting a failure on the cell group. The UE may consider a time alignment (TA) timer related to a TA configuration for the cell group as expired based on initiating the transmission of the failure information. After transmitting the failure information, the UE may receive a configuration for failure recovery of the failure on the cell group. The UE may restart the TA timer related to the TA configuration for the cell group based on receiving the configuration for failure recovery.

### CROSS-REFERENCE TO RELATED APPLICATION(S)

This application is the National Stage filing under 35 U.S.C. 371 of International Application No. PCT/KR2023/001451, filed on Feb. 1, 2023, which claims the benefit of earlier filing date and right of priority to Korean Application No. 10-2022-0019680, filed on Feb. 15, 2022, the contents of which are all hereby incorporated by reference herein in their entireties.

### TECHNICAL FIELD

The present disclosure relates to a time alignment timer handling in wireless communications.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

In wireless communications, time alignment timer is used to evaluate how long serving cells are considered to be uplink time aligned. While the time alignment timer is running, a user equipment (UE) may perform various actions. For example, while the time alignment timer is running, the UE may perform uplink transmissions, and/or perform random access channel (RACH)-less actions (i.e., actions without performing a random access procedure).

### SUMMARY

An aspect of the present disclosure is to provide method and apparatus for a time alignment timer handling in wireless communications.

Another aspect of the present disclosure is to provide method and apparatus for a time alignment timer handling for RACH-less actions in wireless communications.

Another aspect of the present disclosure is to provide method and apparatus for a time alignment timer handling for RACH-less activation of secondary cell group (SCG) in wireless communications.

According to an embodiment of the present disclosure, a method performed by a user equipment (UE) in a wireless communication system comprises: receiving a time alignment (TA) configuration; starting a TA timer related to the TA configuration for a cell group; initiating a transmission of failure information for the cell group based on detecting a failure on the cell group, wherein the TA timer for the cell group expires based on the transmission of the failure information being initiated; transmitting the failure information for the cell group; receiving a configuration for failure recovery of the failure on the cell group after transmitting the failure information; and restarting the TA timer related to the TA configuration for the cell group based on receiving the configuration for failure recovery.

According to an embodiment of the present disclosure, a method performed by a network node adapted to operate in a wireless communication system comprises: transmitting, to a user equipment (UE), a time alignment (TA) configuration; receiving, from the UE, failure information for a cell group on which a failure is detected; and transmitting, to the UE, a configuration for failure recovery of the failure on the cell group after receiving the failure information, wherein a TA timer related to the TA configuration for the cell group expires based on a transmission of the failure information being initiated by the UE, and wherein the TA timer related to the TA configuration for the cell group is restarted based on the configuration for failure recovery being received by the UE.

According to an embodiment of the present disclosure, apparatuses implementing the above methods are described.

The present disclosure can have various advantageous effects.

For example, the valid TA timer remaining upon SCG reactivation is an important factor for RACH-less activation. The reason the UE sends the SCG failure information message may be to obtain reconfiguration for RACH-less activation. According to the present disclosure, the UE obtains a chance to restart the TA timer upon reception of recovery configuration so that the UE can initiate the RACH-less activation, i.e., fast SCG activation.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows another example of wireless devices to which implementations of the present disclosure is applied.

FIG. 5 shows an example of UE to which implementations of the present disclosure is applied.

FIGS. 6 and 7 show an example of protocol stacks in a 3GPP based wireless communication system to which implementations of the present disclosure is applied.

FIG. 8 shows a frame structure in a 3GPP based wireless communication system to which implementations of the present disclosure is applied.

FIG. 9 shows a data flow example in the 3GPP NR system to which implementations of the present disclosure is applied.

FIG. 10 shows an example of a dual connectivity (DC) architecture to which technical features of the present disclosure can be applied.

FIG. 11 shows an example of a method performed by a UE according to an embodiment of the present disclosure.

FIG. 12 shows an example of a signal flow between a UE and a network node according to an embodiment of the present disclosure.

FIG. 13 shows an example of durations of the TA timer based on the last TA timer information according to an embodiment of the present disclosure.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Throughout the disclosure, the terms ‘radio access network (RAN)node’, ‘base station’, ‘eNB’, ‘gNB’ and ‘cell’ may be used interchangeably. Further, a UE may be a kind of a wireless device, and throughout the disclosure, the terms ‘UE’ and ‘wireless device’ may be used interchangeably.

Throughout the disclosure, the terms ‘cell quality’, ‘signal strength’, ‘signal quality’, ‘channel state’, ‘channel quality’, ‘channel state/reference signal received power (RSRP)’ and ‘reference signal received quality (RSRQ)’ may be used interchangeably.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

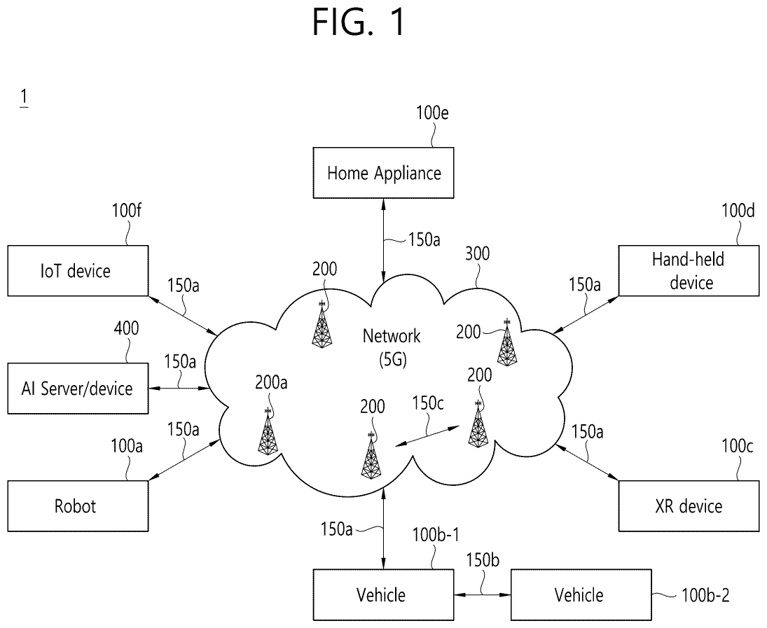

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE)network, a 5G (e.g., NR)network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

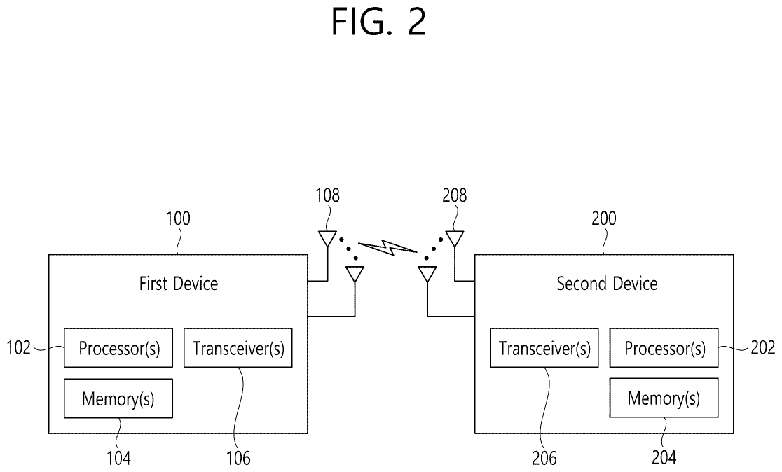

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR). In FIG. 2, (the first wireless device 100 and the second wireless device 200) may correspond to at least one of (the wireless device 100a to 100f and the BS 200), (the wireless device 100a to 100f and the wireless device 100a to 100f) and/or (the BS 200 and the BS 200) of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to/adapted to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to/adapted to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. descriptions, functions, procedures, suggestions, methods and/or operational flowcharts disclosed in the present disclosure may be implemented using firmware or software and the firmware or software may be configured to/adapted to include the modules, procedures, or functions. Firmware or software configured to/adapted to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to/adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports).

The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to/adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to/adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

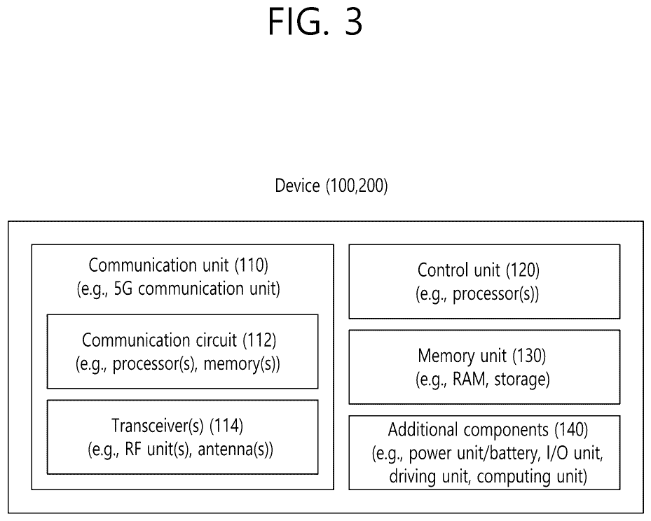

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

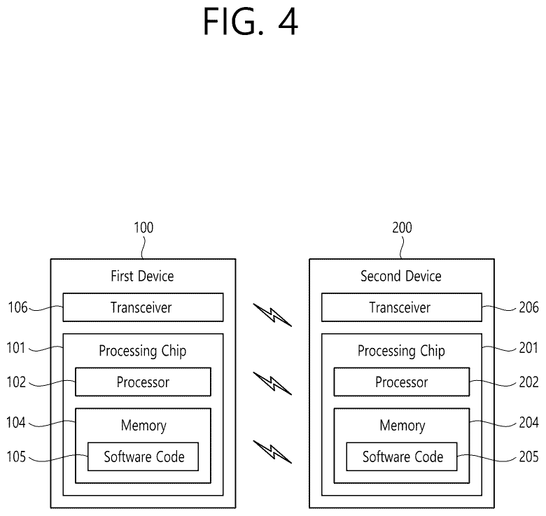

FIG. 4 shows another example of wireless devices to which implementations of the present disclosure is applied.

Referring to FIG. 4, wireless devices 100 and 200 may correspond to the wireless devices 100 and 200 of FIG. 2 and may be configured by various elements, components, units/portions, and/or modules.

The first wireless device 100 may include at least one transceiver, such as a transceiver 106, and at least one processing chip, such as a processing chip 101. The processing chip 101 may include at least one processor, such a processor 102, and at least one memory, such as a memory 104. The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 may perform one or more layers of the radio interface protocol.

The second wireless device 200 may include at least one transceiver, such as a transceiver 206, and at least one processing chip, such as a processing chip 201. The processing chip 201 may include at least one processor, such a processor 202, and at least one memory, such as a memory 204. The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 may perform one or more layers of the radio interface protocol.

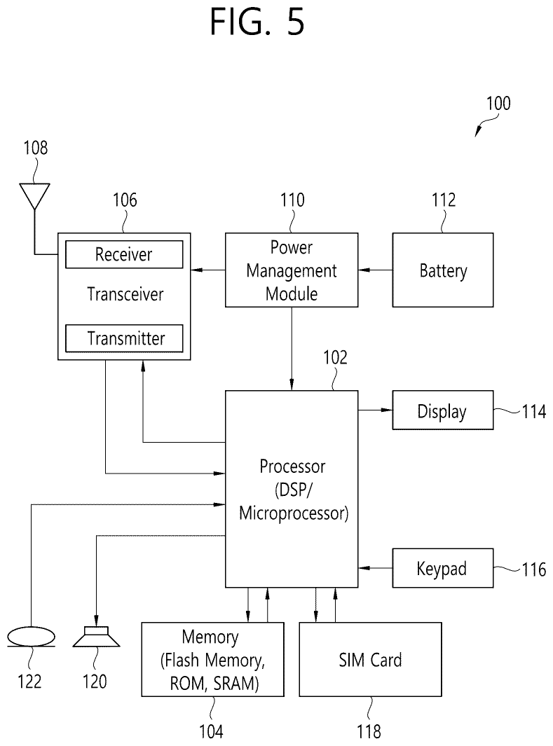

FIG. 5 shows an example of UE to which implementations of the present disclosure is applied.

Referring to FIG. 5, a UE 100 may correspond to the first wireless device 100 of FIG. 2 and/or the first wireless device 100 of FIG. 4.

A UE 100 includes a processor 102, a memory 104, a transceiver 106, one or more antennas 108, a power management module 110, a battery 1112, a display 114, a keypad 116, a subscriber identification module (SIM) card 118, a speaker 120, and a microphone 122.

The processor 102 may be configured to/adapted to implement the descriptions, functions, procedures, suggestions, methods and/or operational flowcharts disclosed in the present disclosure. The processor 102 may be configured to/adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 16 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

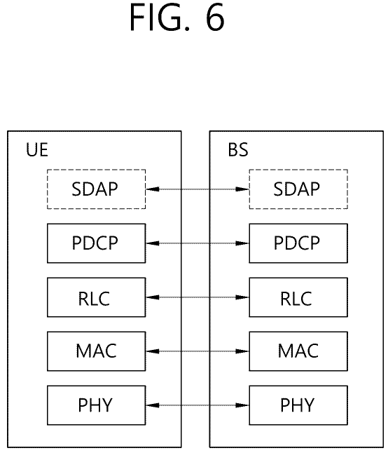

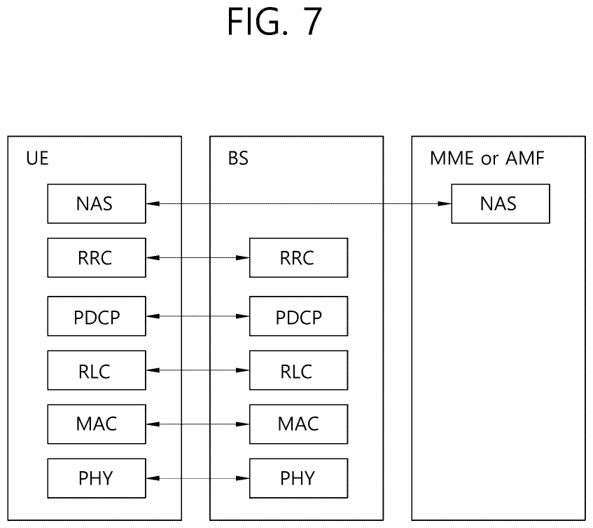

FIGS. 6 and 7 show an example of protocol stacks in a 3GPP based wireless communication system to which implementations of the present disclosure is applied.

In particular, FIG. 6 illustrates an example of a radio interface user plane protocol stack between a UE and a BS and FIG. 7 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 6, the user plane protocol stack may be divided into Layer 1 (i.e., a PHY layer) and Layer 2. Referring to FIG. 7, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

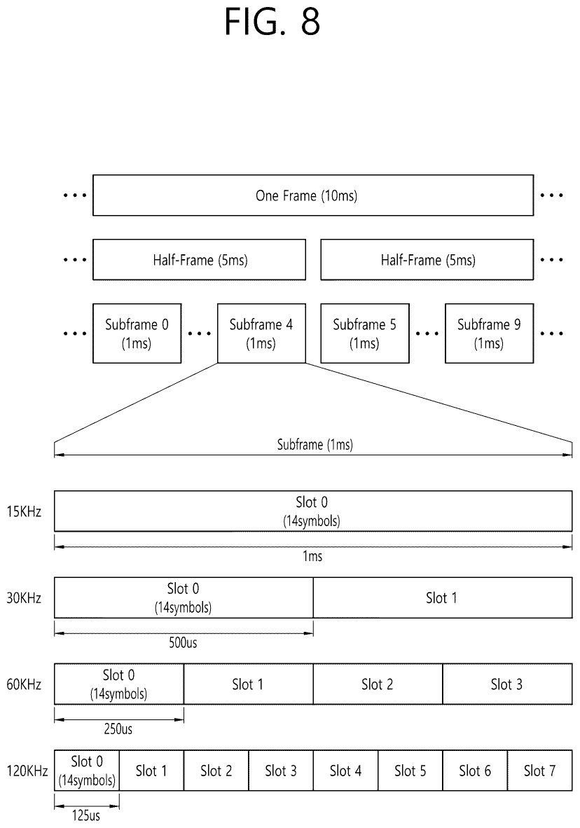

FIG. 8 shows a frame structure in a 3GPP based wireless communication system to which implementations of the present disclosure is applied.

The frame structure shown in FIG. 8 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 8, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing Δf=2^{u}*15 kHz.

Table 1 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 kHz.

TABLE 1

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2*15 kHz.

TABLE 2

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc}. subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index 1 representing a symbol location relative to a reference point in the time domain. In the 3GPP based wireless communication system, an RB is defined by 12 consecutive subcarriers in the frequency domain. In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

The NR frequency band may be defined as two types of frequency range, i.e., FR1 and FR2. The numerical value of the frequency range may be changed. For example, the frequency ranges of the two types (FR1 and FR2) may be as shown in Table 3 below. For ease of explanation, in the frequency ranges used in the NR system, FR1 may mean “sub 6 GHz range”, FR2 may mean “above 6 GHz range,” and may be referred to as millimeter wave (mmW).

TABLE 3

| Frequency Range | Corresponding | | |
|---|---|---|---|
| designation | frequency range | Subcarrier Spacing | |
| FR1 | 450 MHz-6000 MHz | 15, 30, 60 | kHz |
| FR2 | 24250 MHz-52600 MHz | 60, 120, 240 | kHz |

As mentioned above, the numerical value of the frequency range of the NR system may be changed. For example, FR1 may include a frequency band of 410 MHz to 7125 MHz as shown in Table 4 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 4

| Frequency Range | Corresponding | | |
|---|---|---|---|
| designation | frequency range | Subcarrier Spacing | |
| FR1 | 410 MHz-7125 MHz | 15, 30, 60 | kHz |
| FR2 | 24250 MHz-52600 MHz | 60, 120, 240 | kHz |

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times. In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCeIl) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

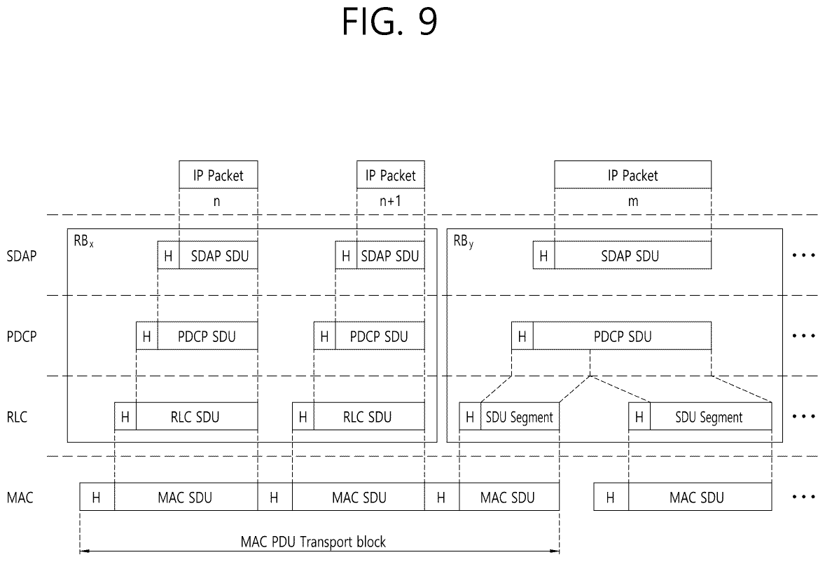

FIG. 9 shows a data flow example in the 3GPP NR system to which implementations of the present disclosure is applied.

Referring to FIG. 9, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

Hereinafter, contents related to maintenance of uplink time alignment (TA) are described.

UE may receive, from a network, a TA configuration via RRC signalling such as SIB1, RRC reconfiguration, UE information response and/or RRC release. The TA configuration may be configured by RRC, and include at least one of the following parameters for the maintenance of UL time alignment:
timeAlignmentTimer (per TAG) which controls how long the MAC entity considers the Serving Cells belonging to the associated TAG to be uplink time aligned;
inactivePosSRS-TimeAlignmentTimer which controls how long the MAC entity considers the Positioning SRS transmission in RRC_INACTIVE to be uplink time aligned;
cg-SDT-TimeAlignmentTimer which controls how long the MAC entity considers the uplink transmission for CG-SDT to be uplink time aligned.

The MAC entity of the UE shall:
1> when a Timing Advance Command MAC CE is received, and if an N_{T}A has been maintained with the indicated TAG:
2> apply the Timing Advance Command for the indicated TAG;
2> if inactivePosSRS-TimeAlignmentTimer is configured and there is ongoing Positioning SRS Transmission in RRC_INACTIVE:
3> start or restart the inactivePosSRS-TimeAlignmentTimer associated with the indicated TAG.
2> if CG-SDT procedure triggered is ongoing:
3> start or restart the cg-SDT-TimeAlignmentTimer associated with the indicated TAG.
2> else:
3> start or restart the timeAlignmentTimer associated with the indicated TAG.
1> when a Timing Advance Command is received in a Random Access Response message for a Serving Cell belonging to a TAG or in a MSGB for an SpCell:
2> if the Random Access Preamble was not selected by the MAC entity among the contention-based Random Access Preamble:
3> apply the Timing Advance Command for this TAG;
3> start or restart the timeAlignmentTimer associated with this TAG.
2> else if the timeAlignmentTimer associated with this TAG is not running:
3> apply the Timing Advance Command for this TAG;
3> start the timeAlignmentTimer associated with this TAG;
3> when the Contention Resolution is considered not successful; or
3> when the Contention Resolution is considered successful for SI request, after transmitting HARQ feedback for MAC PDU including UE Contention Resolution Identity MAC CE:
4> stop timeAlignmentTimer associated with this TAG.
3> when the Contention Resolution is considered not successful:
4> if CG-SDT procedure triggered is ongoing:
5> set the N_{TA} value to the value before applying the received Timing Advance Command.
3> when the Contention Resolution is considered successful for Random Access procedure while the CG-SDT procedure is ongoing:
4> stop timeAlignmentTimer associated with this TAG;
4> start or restart the cg-SDT-TimeAlignmentTimer associated with this TAG.
3> when the Contention Resolution is considered successful for Random Access procedure while SRS transmission in RRC_INACTIVE is ongoing:
4> start or restart the inactivePosSRS-TimeAlignmentTimer associated with this TAG.
2> else:
3> ignore the received Timing Advance Command.
1> when an Absolute Timing Advance Command is received in response to a MSGA transmission including C-RNTI MAC CE:
2> apply the Timing Advance Command for PTAG;
2> if CG-SDT procedure is ongoing:
> start or restart the cg-SDT-TimeAlignmentTimer associated with PTAG.
> else:
> start or restart the timeAlignmentTimer associated with PTAG.
> when instruction from the upper layer has been received for starting the TimeAlignmentTimer associated with PTAG:
> start the TimeAlignmentTimer associated with PTAG.
> when a timeAlignmentTimer expires:
> if the timeAlignmentTimer is associated with the PTAG:
> flush all HARQ buffers for all Serving Cells;
> notify RRC to release PUCCH for all Serving Cells, if configured;
> notify RRC to release SRS for all Serving Cells, if configured;
> clear any configured downlink assignments and configured uplink grants;
> clear any PUSCH resource for semi-persistent CSI reporting;
> consider all running timeAlignmentTimers as expired;
> maintain N_{TA} of all TAGs.
> else if the timeAlignmentTimer is associated with an STAG, then for all Serving Cells belonging to this TAG:
> flush all HARQ buffers;
> notify RRC to release PUCCH, if configured;
> notify RRC to release SRS, if configured;
> clear any configured downlink assignments and configured uplink grants;
> clear any PUSCH resource for semi-persistent CSI reporting;
> maintain N_{TA} of this TAG.

When the MAC entity stops uplink transmissions for an SCell due to the fact that the maximum uplink transmission timing difference between TAGs of the MAC entity or the maximum uplink transmission timing difference between TAGs of any MAC entity of the UE is exceeded, the MAC entity considers the timeAlignmentTimer associated with the SCell as expired.

The MAC entity shall not perform any uplink transmission on a Serving Cell except the Random Access Preamble and MSGA transmission when the timeAlignmentTimer associated with the TAG to which this Serving Cell belongs is not running, CG-SDT procedure is not ongoing or SRS transmission in RRC_INACTIVE is not on-going. Furthermore, when the timeAlignmentTimer associated with the PTAG is not running, CG-SDT procedure is not ongoing and SRS transmission in RRC_INACTIVE is not ongoing, the MAC entity shall not perform any uplink transmission on any Serving Cell except the Random Access Preamble and MSGA transmission on the SpCell. The MAC entity shall not perform any uplink transmission except the Random Access Preamble and MSGA transmission when the cg-SDT-TimeAlignmentTimer is not running during the ongoing CG-SDT procedure. The MAC entity shall not perform any uplink transmission except the Random Access Preamble and MSGA transmission when inactivePosSRS-TimeAlignmentTimer is not running during the procedure for SRS transmission in RRC_INACTIVE.

Hereinafter, contents related to dual connectivity (DC) are described.

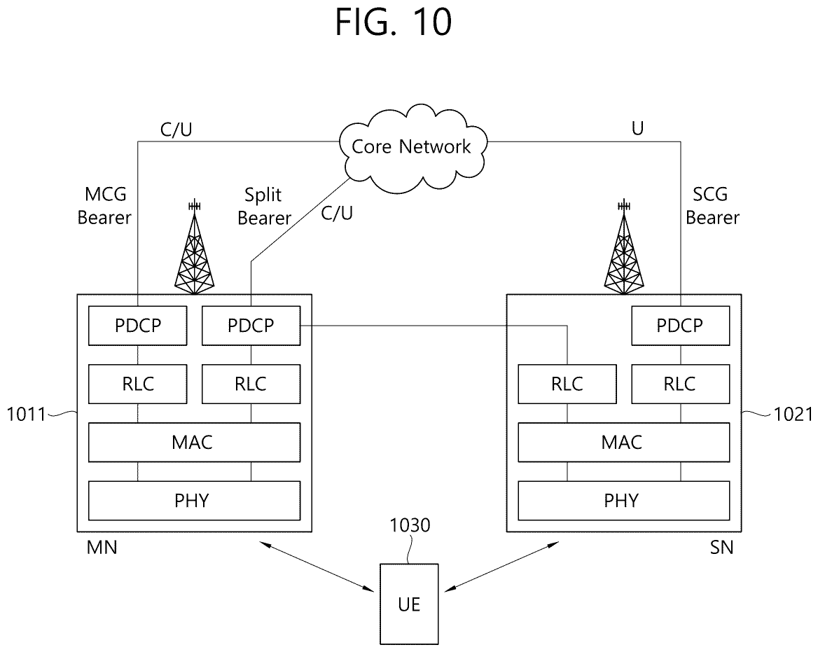

FIG. 10 shows an example of a dual connectivity (DC) architecture to which technical features of the present disclosure can be applied.

Referring to FIG. 10, MN 1011, SN 1021, and a UE 1030 communicating with both the MN 1011 and the SN 1021 are illustrated. As illustrated in FIG. 10, DC refers to a scheme in which a UE (e.g., UE 1030) utilizes radio resources provided by at least two RAN nodes comprising a MN (e.g., MN 1011) and one or more SNs (e.g., SN 1021). In other words, DC refers to a scheme in which a UE is connected to both the MN and the one or more SNs, and communicates with both the MN and the one or more SNs. Since the MN and the SN may be in different sites, a backhaul between the MN and the SN may be construed as non-ideal backhaul (e.g., relatively large delay between nodes).

MN (e.g., MN 1011) refers to a main RAN node providing services to a UE in DC situation. SN (e.g., SN 1021) refers to an additional RAN node providing services to the UE with the MN in the DC situation. If one RAN node provides services to a UE, the RAN node may be a MN. SN can exist if MN exists.

For example, the MN may be associated with macro cell whose coverage is relatively larger than that of a small cell. However, the MN does not have to be associated with macro cell—that is, the MN may be associated with a small cell. Throughout the disclosure, a RAN node that is associated with a macro cell may be referred to as ‘macro cell node’. MN may comprise macro cell node.

For example, the SN may be associated with small cell (e.g., micro cell, pico cell, femto cell) whose coverage is relatively smaller than that of a macro cell. However, the SN does not have to be associated with small cell—that is, the SN may be associated with a macro cell. Throughout the disclosure, a RAN node that is associated with a small cell may be referred to as ‘small cell node’. SN may comprise small cell node.

The MN may be associated with a master cell group (MCG). MCG may refer to a group of serving cells associated with the MN, and may comprise a primary cell (PCell) and optionally one or more secondary cells (SCells). User plane data and/or control plane data may be transported from a core network to the MN through a MCG bearer. MCG bearer refers to a bearer whose radio protocols are located in the MN to use MN resources. As shown in FIG. 10, the radio protocols of the MCG bearer may comprise PDCP, RLC, MAC and/or PHY.

The SN may be associated with a secondary cell group (SCG). SCG may refer to a group of serving cells associated with the SN, and may comprise a primary secondary cell (PSCell) and optionally one or more SCells. User plane data may be transported from a core network to the SN through a SCG bearer. SCG bearer refers to a bearer whose radio protocols are located in the SN to use SN resources. As shown in FIG. 10, the radio protocols of the SCG bearer may comprise PDCP, RLC, MAC and PHY.

User plane data and/or control plane data may be transported from a core network to the MN and split up/duplicated in the MN, and at least part of the split/duplicated data may be forwarded to the SN through a split bearer. Split bearer refers to a bearer whose radio protocols are located in both the MN and the SN to use both MN resources and SN resources. As shown in FIG. 10, the radio protocols of the split bearer located in the MN may comprise PDCP, RLC, MAC and PHY. The radio protocols of the split bearer located in the SN may comprise RLC, MAC and PHY.

According to various embodiments, PDCP anchor/PDCP anchor point/PDCP anchor node refers to a RAN node comprising a PDCP entity which splits up and/or duplicates data and forwards at least part of the split/duplicated data over X2/Xn interface to another RAN node. In the example of FIG. 10, PDCP anchor node may be MN.

According to various embodiments, the MN for the UE may be changed. This may be referred to as handover, or a MN handover.

According to various embodiments, a SN may newly start providing radio resources to the UE, establishing a connection with the UE, and/or communicating with the UE (i.e., SN for the UE may be newly added). This may be referred to as a SN addition.

According to various embodiments, a SN for the UE may be changed while the MN for the UE is maintained. This may be referred to as a SN change.

According to various embodiments, DC may comprise E-UTRAN NR-DC (EN-DC), and/or multi-radio access technology (RAT)-DC (MR-DC). EN-DC refers to a DC situation in which a UE utilizes radio resources provided by E-UTRAN node and NR RAN node. MR-DC refers to a DC situation in which a UE utilizes radio resources provided by RAN nodes with different RATs.

Hereinafter, contents related to SCG activation/deactivation are described.

The UE may deactivate SCG and/or PSCell autonomously, or by receiving an explicit signalling from a network. For example, the UE may deactivate SCG and/or PSCell when the UE receives RRCReconfiguration message and/or RRCResume message including scg-state field from the network.

Upon initiating the SCG deactivation procedure, the UE shall:
> consider the SCG to be deactivated;
> indicate to lower layers that the SCG is deactivated;
> ifbfd-and-RLM is configured to true:
> perform radio link monitoring on the SCG;
> indicate to lower layers to perform beam failure detection on the PSCeIl;
> else:
> stop radio link monitoring on the SCG;
> indicate to lower layers to stop beam failure detection on the PSCell;
> stop timer T310 for this cell group, if running;
> stop timer T312 for this cell group, if running;
> reset the counters N310 and N311;
> if the UE was in RRC_CONNECTED and the SCG was activated before receiving the message for which this procedure is initiated:
> if SRB3 was configured before the reception of the RRCReconfiguration or of the RRCConnectionReconfiguration and SRB3 is not to be released according to any RadioBearerConfig included in the RRCReconfiguration or in the RRCConnectionReconfiguration:
> trigger the PDCP entity of SRB3 to perform SDU discard;
> re-establish the RLC entity of SRB3.

The UE may activate SCG and/or PSCeIl autonomously, or by receiving an explicit signalling from a network. For example, the UE may activate SCG and/or PSCell when the UE receives RRCReconfiguration message and/or RRCResume message not including scg-state field from the network.

Upon initiating the SCG activation procedure, the UE shall:
> if the UE is configured with an SCG after receiving the message for which this procedure is initiated:
> if the UE was configured with a deactivated SCG before receiving the message for which this procedure is initiated:
> consider the SCG to be activated;
> resume performing radio link monitoring on the SCG, if previously stopped;
> indicate to lower layers to resume beam failure detection on the PSCell, if previously stopped;
> indicate to lower layers that the SCG is activated.

Upon initiating the SCG activation procedure, the UE shall:
> if the SCG was deactivated before the reception of the RRCReconfiguration message or the E-UTRA RRCConnectionReconfiguration message for which the SCG activation procedure is executed:
> consider the SCG to be activated;
> indicate to lower layers that the SCG is activated;
> resume performing radio link monitoring on the SCG, if previously stopped;
> indicate to lower layers to resume beam failure detection on the PSCell, if previously stopped;
> if bfd-and-RLM was not configured to true before the reception of the RRCReconfiguration message or the E-UTRA RRCConnectionReconfiguration message for which the procedure invoking the SCG activation procedure is executed; or
> if lower layers indicate that a Random Access procedure is needed for SCG activation:
> initiate the Random Access procedure on the PSCell.

The network may activate and deactivate the configured SCG.

The MAC entity of the UE shall for the configured SCG:
> if upper layers indicate that SCG is activated:
> if BFI_COUNTER>=beamFailurelnstanceMaxCount for the PSCeIl or the timeAlignmentTimer associated with PTAG is not running:
> indicate to upper layers that a Random Access Procedure is needed for SCG activation.
> else:
> activate the SCG according to the timing for direct SCG activation (i.e., RACH-less SCG activation, and/or SCG activation without performing random access procedure).
> (re-)initialize any suspended configured uplink grants of configured grant Type 1 associated with this PSCell according to the stored configuration, if any, and to start in the symbol;
> apply normal SCG operation including:
> SRS transmissions on the PSCeIl;
> CSI reporting for the PSCell;
> PDCCH monitoring on the PSCell;
> PUCCH transmissions on the PSCeIl;
> transmit on RACH on the PSCell;
> initialize Bj for each logical channel to zero.
> else if upper layers indicate that the SCG is deactivated:
> deactivate all the SCells of the SCG;
> deactivate SCG according to the timing;
> clear any configured downlink assignment and any configured uplink grant Type 2 associated with the PSCeIl respectively;
> suspend any configured uplink grant Type 1 associated with the PSCell;
> reset MAC.
> if the SCG is deactivated:
> not transmit SRS on the PSCell;
> not report CSI for the PSCeIl;
> not transmit on UL-SCH on the PSCell;
> not transmit PUCCH on the PSCell;
> not transmit on RACH on the PSCell;
> not monitor the PDCCH on the PSCell.

Hereinafter, contents related to radio link monitoring (RLM) are described.

The UE may perform RLM on a cell to detect physical layer problems on the cell/cell group in RRC_CONNECTED, recover the physical layer problems on the cell/cell group, and/or detect a radio link failure (RLF) on the cell/cell group. Therefore, the RLM may comprise monitoring whether physical layer problems are detected on a cell/cell group, monitoring whether the physical layer problems are recovered on a cell/cell group, and/or monitoring whether an RLF is detected on a cell/cell group. Monitoring whether physical layer problems are detected on a cell/cell group may comprise monitoring a number of consecutive “out-of-sync” indications for the source SpCell. Monitoring whether the physical layer problems are recovered on a cell/cell group may comprise monitoring a number of consecutive “in-sync” indications for the SpCell.

To detect physical layer problems in RRC_CONNECTED, the UE shall:
> if any DAPS bearer is configured, upon receiving N310 consecutive “out-of-sync” indications for the source SpCell from lower layers and T304 is running:
> start timer T310 for the source SpCell.
> upon receiving N310 consecutive “out-of-sync” indications for the SpCell from lower layers while neither T300, T301, T304, T311, T316 nor T319 are running:
> start timer T310 for the corresponding SpCell.

Upon receiving N311 consecutive “in-sync” indications for the SpCell from lower layers while T310 is running, the UE may determine that the physical layer problems are recovered on a cell/cell group, and the UE shall:
> stop timer T310 for the corresponding SpCell.
> stop timer T312 for the corresponding SpCell, if running.

In this case, the UE maintains the RRC connection without explicit signalling, i.e. the UE maintains the entire radio resource configuration.

Periods in time where neither “in-sync” nor “out-of-sync” is reported by Li do not affect the evaluation of the number of consecutive “in-sync” or “out-of-sync” indications.

To detect an RLF on an MCG, the UE shall:
> upon T310 expiry in PCell; or
> upon T312 expiry in PCell; or
> upon random access problem indication from MCG MAC while neither T300, T301, T304, T311 nor T319 are running; or
> upon indication from MCG RLC that the maximum number of retransmissions has been reached; or
> if connected as an IAB-node, upon BH RLF indication received on BAP entity from the MCG; or
> upon consistent uplink LBT failure indication from MCG MAC while T304 is not running:
> if the indication is from MCG RLC and CA duplication is configured and activated for MCG, and for the corresponding logical channel allowedServingCells only includes SCell(s):
> initiate the failure information procedure.
> else:
> consider radio link failure to be detected for the MCG, i.e. MCG RLF.

After detecting the RLF on the MCG, i) if T316 is configured, ii) if SCG transmission is not suspended, iii) if the SCG is not deactivated, and iv) if neither PSCell change nor PSCell addition is ongoing (i.e. timer T304 for the NR PSCell is not running in case of NR-DC or timer T307 of the E-UTRA PSCell is not running in NE-DC), the UE may initiate the MCG failure information procedure to report MCG radio link failure. Else, the UE may initiate the connection re-establishment procedure.

To detect an RLF on an SCG, the UE shall:
1> upon T310 expiry in PSCell; or
1> upon T312 expiry in PSCell; or
1> upon random access problem indication from SCG MAC; or
1> upon indication from SCG RLC that the maximum number of retransmissions has been reached; or
1> if connected as an IAB-node, upon BH RLF indication received on BAP entity from the SCG; or
1> upon consistent uplink LBT failure indication from SCG MAC:
2> if the indication is from SCG RLC and CA duplication is configured and activated for SCG, and for the corresponding logical channel allowedServingCells only includes SCell(s):
3> initiate the failure information procedure to report RLC failure.
2> else:
3> consider radio link failure to be detected for the SCG, i.e. SCG RLF;
3> if MCG transmission is not suspended:
4> initiate the SCG failure information procedure to report SCG radio link failure.
3> else:
4> if the UE is in NR-DC:
5> initiate the connection re-establishment procedure;
4> else (the UE is in (NG)EN-DC):
5> initiate the connection re-establishment procedure.

Hereinafter, beam failure detection (BFD) and recovery procedure are described.

UE may perform a BFD to detect a beam failure and trigger a beam failure recovery (BFR). When the UE detects a beam failure, the UE may trigger a BFR. Performing a BFD may comprise monitoring a number of beam failure instance indications for a BFD reference signal (BFD-RS) set(s).

The MAC entity may be configured by RRC per Serving Cell with a beam failure recovery procedure which is used for indicating to the serving gNB of a new SSB or CSI-RS when beam failure is detected on the serving SSB(s)/CSI-RS(s). Beam failure is detected by counting beam failure instance indication from the lower layers to the MAC entity. If beamFailureRecoveryConfig is reconfigured by upper layers during an ongoing Random Access procedure for beam failure recovery for SpCell, the MAC entity shall stop the ongoing Random Access procedure and initiate a Random Access procedure using the new configuration. When the SCG is deactivated, the UE performs beam failure detection on the PSCell if bfd-and-RLM is set to true.

RRC configures parameters for the Beam Failure Detection and Recovery procedure in the beamFailureRecoveryConfig, beamFailureRecoverySpCellConfig, beamFailureRecoverySCellConfig and the radioLinkMonitoringConfig.

The MAC entity shall for each Serving Cell configured for beam failure detection:
> if the Serving Cell is configured with two BFD-RS sets:
> if beam failure instance indication for a BFD-RS set has been received from lower layers:

> start or restart the beamFailureDetectionTimer of the BFD-RS set;

> increment BFI_COUNTER of the BFD-RS set by 1;

> if BFI_COUNTER of the BFD-RS set>=beamFailurelnstanceMaxCount:

> trigger a BFR for this BFD-RS set of the Serving Cell;

> if BFR is triggered for both BFD-RS sets of the SpCell and the Beam Failure Recovery procedure is not successfully completed for any of the BFD-RS sets:
> initiate a Random Access procedure on the SpCell;
> if the Serving Cell is SpCell and the Random Access procedure initiated for beam failure recovery of both BFD-RS sets of SpCell is successfully completed:
> set BFI_COUNTER of each BFD-RS set of SpCell to 0.
> consider the Beam Failure Recovery procedure successfully completed.
> if the beamFailureDetectionTimer of this BFD-RS set expires; or
> if beamFailureDetectionTimer, beamFailurelnstanceMaxCount, or any of the reference signals used for beam failure detection is reconfigured by upper layers or by the BFD-RS Indication MAC CE associated with a BFD-RS set of the Serving Cell:
> set BFI_COUNTER of the BFD-RS set to 0.
> if a PDCCH addressed to C-RNTI indicating uplink grant for a new transmission is received for the HARQ process used for the transmission of the Enhanced BFR MAC CE or Truncated Enhanced BFR MAC CE which contains beam failure recovery information of this BFD-RS set of the Serving Cell:
> set BFI_COUNTER of the BFD-RS set to 0;
> consider the Beam Failure Recovery procedure successfully completed for this BFD-RS set and cancel all the triggered BFRs of this BFD-RS set of the Serving Cell.
> if the Serving Cell is SCell and the SCell is deactivated:
> set BFI_COUNTER of each BFD-RS set of SCell to 0;
> consider the Beam Failure Recovery procedure successfully completed and cancel all the triggered BFRs of all BFD-RS sets of the Serving Cell.
> else:
> if beam failure instance indication has been received from lower layers:
> start or restart the beamFailureDetectionTimer;
> increment BFI_COUNTER by 1;
> if BFI_COUNTER>=beamFailurelnstanceMaxCount:
> if the Serving Cell is SCell:
> trigger a BFR for this Serving Cell;
> else if the Serving Cell is PSCell and, the SCG is deactivated:
> if beam failure of the PSCell has not been indicated to upper layers since the SCG was deactivated or since the deactivated SCG was last reconfigured with BFD-RS:
> indicate beam failure of the PSCell to upper layers (that is, upon detecting a beam failure while the SCG is deactivated, UE indicates beam failure to network via RRC so the network can reconfigure the UE to keep the PSCeIl and allow RACH-less activation by changing BFD RS).

After beam failure is indicated to upper layers, the UE may stop the beamFailureDetectionTimer and lower layer beam failure indication while BFI_COUNTER>=beamFailurelnstanceMaxCount for the deactivated SCG.
> else:
> initiate a Random Access procedure on the SpCell.
> if the beamFailureDetectionTimer expires; or
> if beamFailureDetectionTimer, beamFailurelnstanceMaxCount, or any of the reference signals used for beam failure detection is reconfigured by upper layers associated with this Serving Cell:
> set BFI_COUNTER to 0.
> if the Serving Cell is SpCell and the Random Access procedure initiated for SpCell beam failure recovery is successfully completed:
> set BFI_COUNTER to 0;
> stop the beamFailureRecoveryTimer, if configured;
> consider the Beam Failure Recovery procedure successfully completed.
> else if the Serving Cell is SCell, and a PDCCH addressed to C-RNTI indicating uplink grant for a new transmission is received for the HARQ process used for the transmission of the MAC CE for BFR which contains beam failure recovery information of this Serving Cell; or
2> if the SCell is deactivated:
3> set BFI_COUNTER to 0;
3> consider the Beam Failure Recovery procedure successfully completed and cancel all the triggered BFRs for this Serving Cell.

The MAC entity shall:
1> if the Beam Failure Recovery procedure determines that at least one BFR has been triggered and not cancelled for an SCell for which evaluation of the candidate beams has been completed and if none of the Serving Cell(s) of this MAC entity are configured with two BFD-RS sets:
2> if UL-SCH resources are available for a new transmission and if the UL-SCH resources can accommodate the BFR MAC CE plus its subheader as a result of LCP:
3> instruct the Multiplexing and Assembly procedure to generate the BFR MAC CE.
2> else if UL-SCH resources are available for a new transmission and if the UL-SCH resources can accommodate the Truncated BFR MAC CE plus its subheader as a result of LCP:
3> instruct the Multiplexing and Assembly procedure to generate the Truncated BFR MAC CE.
2> else:
3> trigger the SR for SCell beam failure recovery for each SCell for which BFR has been triggered, not cancelled, and for which evaluation of the candidate beams has been completed.
1> if the Beam Failure Recovery procedure determines that at least one BFR for any BFD-RS set has been triggered and not cancelled for an SCell for which evaluation of the candidate beams has been completed; or
1> if the Beam Failure Recovery procedure determines that at least one BFR for only one BFD-RS set has been triggered and not cancelled for an SpCell for which evaluation of the candidate beams has been completed; or
1> if the Beam Failure Recovery procedure determines that at least one BFR has been triggered and not cancelled for an SCell for which evaluation of the candidate beams has been completed and if at least one Serving Cell of this MAC entity is configured with two BFD-RS sets:
2> if UL-SCH resources are available for a new transmission and if the UL-SCH resources can accommodate the Enhanced BFR MAC CE plus its subheader as a result of LCP:
3> instruct the Multiplexing and Assembly procedure to generate the Enhanced BFR MAC CE.
2> else if UL-SCH resources are available for a new transmission and if the UL-SCH resources can accommodate the Truncated Enhanced BFR MAC CE plus its subheader as a result of LCP:
3> instruct the Multiplexing and Assembly procedure to generate the Truncated Enhanced BFR MAC CE.
2> else:
3> trigger the SR for beam failure recovery of each BFD-RS set for which BFR has been triggered, not cancelled, and for which evaluation of the candidate beams has been completed;
3> trigger the SR for SCell beam failure recovery for each SCell for which BFR has been triggered, not cancelled, and for which evaluation of the candidate beams has been completed.

All BFRs triggered for an SCell shall be cancelled when a MAC PDU is transmitted and this PDU includes a MAC CE for BFR which contains beam failure information of that SCell. All BFRs triggered for a BFD-RS set of a Serving Cell shall be cancelled when a MAC PDU is transmitted and this PDU includes an Enhanced BFR MAC CE or Truncated Enhanced BFR MAC CE which contains beam failure recovery information of that BFD-RS set of the Serving Cell.

Hereinafter, SCG failure information procedure is described.

The purpose of the SCG failure information procedure is to inform E-UTRAN or NR MN about an SCG failure the UE has experienced i.e. SCG radio link failure, beam failure of the PSCell while the SCG is deactivated, failure of SCG reconfiguration with sync, SCG configuration failure for RRC message on SRB3, SCG integrity check failure, and consistent uplink LBT failures on PSCeIl for operation with shared spectrum channel access.

A UE initiates the SCG failure information procedure to report SCG failures when neither MCG nor SCG transmission is suspended and when one of the following conditions is met:
1> upon detecting radio link failure for the SCG;
1> upon detecting beam failure of the PSCeIl while the SCG is deactivated;
1> upon reconfiguration with sync failure of the SCG;
1> upon SCG configuration failure;
1> upon integrity check failure indication from SCG lower layers concerning SRB3.

Upon initiating the SCG failure information procedure, the UE shall:
1> if the procedure was not initiated due to beam failure of the PSCell while the SCG is deactivated:
2> suspend SCG transmission for all SRBs, DRBs and, if any, BH RLC channels;
2> reset SCG MAC;
1> stop T304 for the SCG, if running;
1> stop conditional reconfiguration evaluation for CPC or CPA, if configured;
1> if the UE is in (NG)EN-DC:
2> initiate transmission of the SCGFailureInformationNR message.
1> else:
2> initiate transmission of the SCGFailureInformation message.

If a reset of the MAC entity is requested by upper layers or the reset of the MAC entity is triggered due to SCG deactivation, the MAC entity shall:
1> if the MAC reset is not due to SCG deactivation:
2> initialize Bj for each logical channel to zero;
1> initialize SBj for each logical channel to zero if Sidelink resource allocation mode 1 is configured by RRC;
1> if upper layers indicate SCG deactivation and bfd-and-RLM with value true is configured for the deactivated SCG:
2> stop (if running) all timers except beamFailureDetectionTimer associated with PSCell and timeAlignmentTimers (i.e., upon SCG deactivation, UE keeps all timeAlignmentTimers (e.g. associated with the PTAG and STAG) running, if configured. UE stops (if running) all timers except beamFailureDetectionTimer associated with PSCeIl and timeAlignmentTimers upon SCG deactivation as a part of partial MAC reset).
1> else:
2> stop (if running) all timers, except MBS broadcast DRX timers;
2> consider all timeAlignmentTimers, inactivePosSRS-TimeAlignmentTimer, and cg-SDT-TimeAlignmentTimer, if configured, as expired and perform procedures related to maintenance of uplink time alingment;

The UE may transmit the SCGFailureInformation message to MN, or SN via the MN. After transmitting the SCGFailureInformation message, the UE may receive RRCReconfiguration message or RRCRelease message from the MN/SN. Upon receiving the RRCReconfiguration message, the UE may determine that the SCG failure is recovered, and resume SCG transmissions. Upon receiving the RRCRelease message, the UE may determine that the SCG failure is not recovered, and release SCG bearers and/or configurations.

Meanwhile, the UE can initiate RACH-less activation of SCG, i.e., triggering scheduling request (SR) without random access channel (RACH), as a fast SCG activation when SCG needs to be activated. To initiate the RACH-less activation, there are several conditions like below:
1) No radio link failure (RLF)
2) No beam failure (BF)
3) No time alignment timer (TAT) expiry
4) Indication from the network to allow the RACH-less activation

That is, the UE may initiate the RACH-less activation of SCG when one or more of the conditions 1 to 4 are satisfied, where:
Condition 1) RLF is not detected or RLF is recovered;
Condition 2) BF is not detected or BF is recovered;
Condition 3) TAT does not expire or is running;
Condition 4) there is an indication from the network to allow the RACH-less activation. However, while SCG is deactivated, if the UE detects beam failure or radio link failure on PSCell, the UE may regard the TA timer as expired on the way of sending SCG failure information message to the network. Thus, even though the network provides recovery reconfiguration which enables to resume radio link monitoring (RLM) and beam failure detection (BFD) to the UE before SCG activation (i.e., condition 1 and 2 are satisfied and condition 4 is assumed to be satisfied), the UE cannot initiate the RACH-less activation due to TAT expiry, unlike the network intention.

Therefore, a way of mechanisms is needed to initiate the RACH-less activation if the network allows the RACH-less activation even after SCG failure on the deactivated SCG.

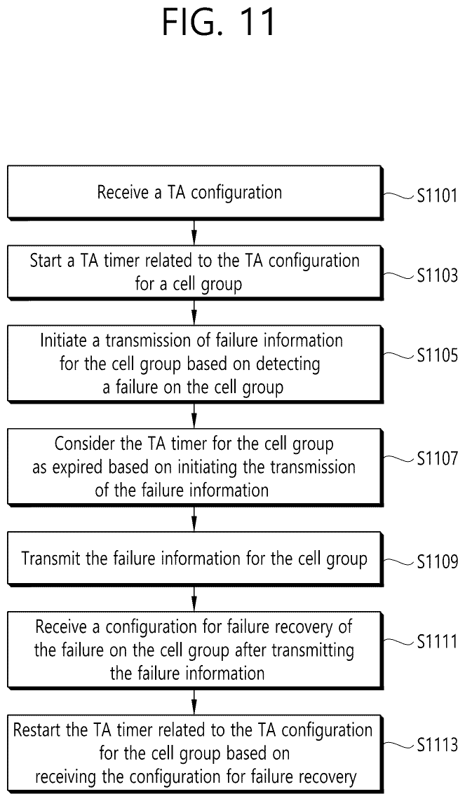

FIG. 11 shows an example of a method performed by a UE according to an embodiment of the present disclosure. The method may also be performed by a wireless device.

Referring to FIG. 11, in step S1101, UE may receive a TA configuration (e.g., timeAlignmentTimer). The UE may receive a system information block type 1 (SIB1), RRC reconfiguration message, UE information response message and/or RRC release message including the TA configuration.

In step S1103, the UE may start a TA timer related to the TA configuration for a cell group. While the TA timer for the cell group is running, the UE may consider that uplink timing to the cell group is aligned.

In step S1105, the UE may initiate a transmission of failure information for the cell group based on detecting a failure on the cell group. The UE may perform a link monitoring on the cell group, and detect a failure on the cell group based on the link monitoring.

In step S1107, the UE may consider the TA timer for the cell group as expired based on initiating the transmission of the failure information. The UE may reset MAC based on initiating the transmission of the failure information, and consider the TA timer for the cell group as expired according to the MAC reset.

In step S1109, the UE may transmit the failure information for the cell group. The failure information may be transmitted via another cell group on which failure is not detected.

In step S1111, the UE may receive a configuration for failure recovery of the failure on the cell group after transmitting the failure information. The configuration for failure recovery may be included in RRC reconfiguration message.

In step S1113, the UE may restart the TA timer related to the TA configuration for the cell group based on receiving the configuration for failure recovery.

According to various embodiments, the UE may restart the TA timer related to the TA configuration for the cell group upon a reception of the configuration for failure recovery.

According to various embodiments, the TA timer may have a time duration. The UE may restart the TA timer related to the TA configuration for the cell group, based on receiving the configuration for failure recovery within the time duration from when the TA timer is started.

According to various embodiments, the restarted TA timer may run for a rest time period of the time duration. The rest time period may be the time duration minus a time period from when the TA timer is started to a time point. The time point comprises at least one of: a time point when the configuration for failure recovery is received; or a time point when the TA timer is restarted.

According to various embodiments, the TA configuration may be received before the configuration for failure recovery is received.

According to various embodiments, the UE may determine that the failure on the cell group is recovered based on receiving the configuration for failure recovery.

According to various embodiments, the UE may deactivate the cell group. While the cell group is deactivated, the UE may perform a link monitoring on the cell group, and detect the failure on the cell group based on the link monitoring. While the cell group is deactivated, the UE may initiate the transmission of the failure information for the cell group based on detecting the failure on the cell group.

According to various embodiments, the link monitoring may comprise at least one of a radio link monitoring (RLM) or a beam failure detection (BFD). The failure may comprise at least one of a radio link failure (RLF) related to the RLM or a beam failure (BF) related to the BFD.

According to various embodiments, the UE may activate the cell group without performing a random access to the cell group, while the TA timer is running after restarting the TA timer.

According to various embodiments, the UE may perform a random access channel (RACH)-less activation of the cell group based on at least one of conditions being met. The conditions may comprise a condition that a radio link failure (RLF) is not detected or RLF is recovered; a condition that a beam failure (BF) is not detected or BF is recovered; a condition that the TA timer does not expire or is running; and a condition that an indication to perform the RACH-less activation is received from a network.

According to various embodiments, the UE may activate the cell group by performing a random access to the cell group, after the TA timer expires.

According to various embodiments, the cell group may comprise a secondary cell group (SCG) including a primary secondary cell (PSCell).

According to various embodiments, the UE may report a beam failure information. The UE may reset a MAC entity including stopping a timeAlignmentTimer for a timing advance group (TAG). The UE may receive an RRC message including the beam failure recovery information. The UE may restart the timeAlignmentTimer for the TAG if the RRC message is received within a time duration from the resetting of the MAC entity.

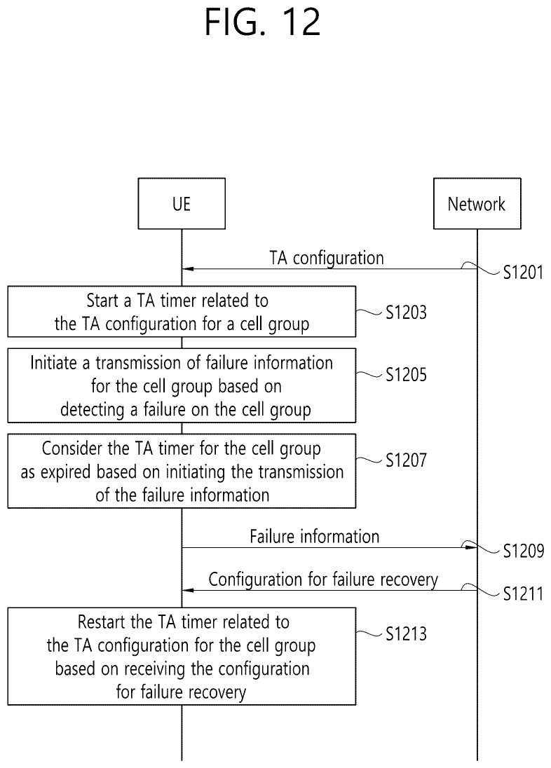

FIG. 12 shows an example of a signal flow between a UE and a network node according to an embodiment of the present disclosure. The network node may comprise a RAN node, such as base station (BS). For example, the RAN node may be a MN associated with MCG.

Referring to FIG. 12, in step S1201, the network node may transmit, to a UE, a TA configuration. The network node may transmit a system information block type 1 (SIB1), RRC reconfiguration message, UE information response message and/or RRC release message including the TA configuration.

In step S1203, the UE may start a TA timer related to the TA configuration for a cell group. While the TA timer for the cell group is running, the UE may consider that uplink timing to the cell group is aligned.

In step S1205, the UE may initiate a transmission of failure information for the cell group based on detecting a failure on the cell group. The UE may perform a link monitoring on the cell group, and detect a failure on the cell group based on the link monitoring.

In step S1207, the UE may consider the TA timer for the cell group as expired based on initiating the transmission of the failure information. The UE may reset MAC based on initiating the transmission of the failure information, and consider the TA timer for the cell group as expired according to the MAC reset.

In step S1209, the network node may receive, from the UE, the failure information for the cell group on which the failure is detected. The cell group may be different from a cell group associated with the network node.

In step S1211, the network node may transmit, to the UE, a configuration for failure recovery of the failure on the cell group after receiving the failure information. The network node may transmit RRC reconfiguration message including the configuration for failure recovery.

In step S1213, the UE may restart the TA timer related to the TA configuration for the cell group based on receiving the configuration for failure recovery.

In the present disclosure, if the UE receives an RRC signalling for recovery of SCG after sending the SCG failure information, the UE may restart the TA timer upon reception of the RRC signalling for recovery after checking whether a condition is met to restart the TA timer. The condition may be used to indicate whether the UE is allowed to restart the TA timer. The condition may be at least one of the followings:
1) If a certain timer value is additionally provided from the network and if the certain timer is still running after starting the certain timer when sending SCG failure information;
2) If a pre-defined timer value is used without additional information from the network and if the predefined timer is still running after starting the certain timer when sending SCG failure information; or
3) If the RRC signalling for recovery is received by the UE before the time of TA expiry when SCG failure is assumed not to be detected, i.e., the UE checks whether the last TA timer can be regarded as still valid if SCG failure was not detected.

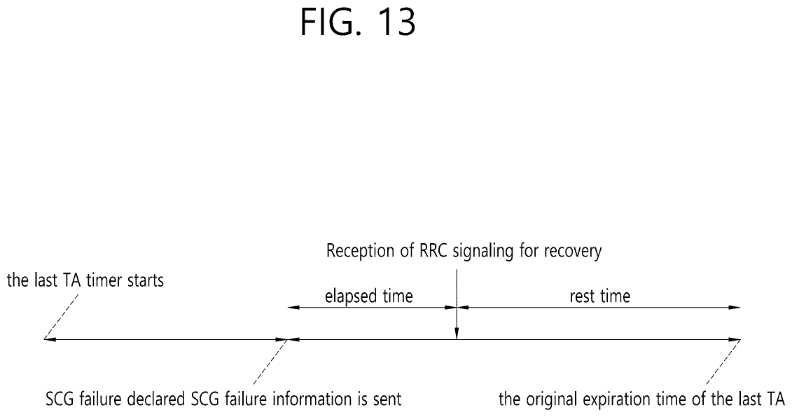

If the condition is met, the UE may restart the TA timer immediately. If the network provides a new TA timer information in the RRC signalling for recovery, the UE may restart the TA timer with the new TA timer information. If the network doesn't provide any new TA timer information in the RRC signalling for recovery, the UE may restart the TA timer with the last TA timer information, as shown in FIG. 13.

FIG. 13 shows an example of durations of the TA timer based on the last TA timer information according to an embodiment of the present disclosure.

Referring to FIG. 13, as the last TA timer information, the UE may restart the TA timer with the rest time of the last TA timer. For the rest time of the last TA timer, the UE may assume that the TA timer has been running continuously, and calculate the rest time considering the original expiration time and elapsed time until reception of the RRC signalling for recovery. For example, the reset time may be a time duration of the TA timer minus a time period from when the TA timer is started to a time point, where the time point comprises at least one of i) a time point when the RRC signalling for recovery is received, or ii) a time point when the TA timer is restarted.

After restarting the TA timer, when the UE initiates to activate SCG, the UE may regard the TA timer as still valid if the TA timer is still running. Then, the UE can perform RACH-less activation if all conditions are met.

Regarding a maintenance of uplink time alignment, the MAC entity of the UE shall:
> while SCG is deactivated, when timeAlignmentTimer configuration is received from upper layer if the certain timer which has been additionally provided to restart timeAlignmentTimer still running:
> start or restart the timeAlignmentTimer associated with PTAG;
1> while SCG is deactivated, when RRC signaling is received for SCG failure recovery and the last timeAlignmentTimer can be regarded as still running if the UE assumes that the TA timer has been running continuously:
> restart the timeAlignmentTimer associated with PTAG with the remaining time until expiry time when the UE assumes that the TA timer has been running continuously.

Furthermore, the method in perspective of the UE described above in FIG. 11 may be performed by first wireless device 100 shown in FIG. 2, the wireless device 100 shown in FIG. 3, the first wireless device 100 shown in FIG. 4 and/or the UE 100 shown in FIG. 5.

More specifically, the UE comprises at least one transceiver, at least processor, and at least one computer memory operably connectable to the at least one processor and storing instructions that, based on being executed by the at least one processor, perform operations.

The operations comprise: receiving a time alignment (TA) configuration; starting a TA timer related to the TA configuration for a cell group; initiating a transmission of failure information for the cell group based on detecting a failure on the cell group, wherein the TA timer for the cell group expires based on the transmission of the failure information being initiated; transmitting the failure information for the cell group; receiving a configuration for failure recovery of the failure on the cell group after transmitting the failure information; and restarting the TA timer related to the TA configuration for the cell group based on receiving the configuration for failure recovery.

Furthermore, the method in perspective of the UE described above in FIG. 11 may be performed by a software code 105 stored in the memory 104 included in the first wireless device 100 shown in FIG. 4.

More specifically, at least one computer readable medium (CRM) stores instructions that, based on being executed by at least one processor, perform operations comprising: receiving a time alignment (TA) configuration; starting a TA timer related to the TA configuration for a cell group; initiating a transmission of failure information for the cell group based on detecting a failure on the cell group, wherein the TA timer for the cell group expires based on the transmission of the failure information being initiated; transmitting the failure information for the cell group; receiving a configuration for failure recovery of the failure on the cell group after transmitting the failure information; and restarting the TA timer related to the TA configuration for the cell group based on receiving the configuration for failure recovery.

Furthermore, the method in perspective of the UE described above in FIG. 11 may be performed by control of the processor 102 included in the first wireless device 100 shown in FIG. 2, by control of the communication unit 110 and/or the control unit 120 included in the wireless device 100 shown in FIG. 3, by control of the processor 102 included in the first wireless device 100 shown in FIG. 4 and/or by control of the processor 102 included in the UE 100 shown in FIG. 5.

More specifically, an apparatus configured to/adapted to operate in a wireless communication system (e.g., wireless device/UE) comprises at least processor, and at least one computer memory operably connectable to the at least one processor. The at least one processor is configured to/adapted to perform operations comprising: receiving a time alignment (TA) configuration; starting a TA timer related to the TA configuration for a cell group; initiating a transmission of failure information for the cell group based on detecting a failure on the cell group, wherein the TA timer for the cell group expires based on the transmission of the failure information being initiated; transmitting the failure information for the cell group; receiving a configuration for failure recovery of the failure on the cell group after transmitting the failure information; and restarting the TA timer related to the TA configuration for the cell group based on receiving the configuration for failure recovery.

Furthermore, the method in perspective of the network node described above may be performed by second wireless device 100 shown in FIG. 2, the device 100 shown in FIG. 3, and/or the second wireless device 200 shown in FIG. 4.

More specifically, the network node comprises at least one transceiver, at least processor, and at least one computer memory operably connectable to the at least one processor and storing instructions that, based on being executed by the at least one processor, perform operations.

The operations comprise: transmitting, to a user equipment (UE), a time alignment (TA) configuration; receiving, from the UE, failure information for a cell group on which a failure is detected; and transmitting, to the UE, a configuration for failure recovery of the failure on the cell group after receiving the failure information, wherein a TA timer related to the TA configuration for the cell group expires based on a transmission of the failure information being initiated by the UE, and wherein the TA timer related to the TA configuration for the cell group is restarted based on the configuration for failure recovery being received by the UE.

The present disclosure can have various advantageous effects.

For example, the valid TA timer remaining upon SCG reactivation is an important factor for RACH-less activation. The reason the UE sends the SCG failure information message may be to obtain reconfiguration for RACH-less activation. According to the present disclosure, the UE obtains a chance to restart the TA timer upon reception of recovery configuration so that the UE can initiate the RACH-less activation, i.e., fast SCG activation.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method performed by a user equipment (UE) in a wireless communication system, the method comprising:
receiving a time alignment (TA) configuration;
starting a TA timer related to the TA configuration for a cell group:
initiating a transmission of failure information for the cell group based on detecting a failure on the cell group, wherein the TA timer for the cell group expires based on the transmission of the failure information being initiated:
transmitting the failure information for the cell group:
receiving a configuration for failure recovery of the failure on the cell group after transmitting the failure information; and
restarting the TA timer related to the TA configuration for the cell group based on receiving the configuration for failure recovery.

2. The method of claim 1, wherein the restarting of the TA timer comprises restarting the TA timer related to the TA configuration for the cell group upon a reception of the configuration for failure recovery.

3. The method of claim 1, wherein the TA timer has a time duration, and
wherein the restarting of the TA timer comprises restarting the TA timer related to the TA configuration for the cell group, based on receiving the configuration for failure recovery within the time duration from when the TA timer is started.

4. The method of claim 3, wherein the restarted TA timer runs for a rest time period of the time duration,
wherein the rest time period is the time duration minus a time period from when the TA timer is started to a time point, and
wherein the time point comprises at least one of:
a time point when the configuration for failure recovery is received: or
a time point when the TA timer is restarted.

5. The method of claim 1, wherein the TA configuration is received before the configuration for failure recovery is received.

6. The method of claim 1, further comprising:
determining that the failure on the cell group is recovered based on receiving the configuration for failure recovery.

7. The method of claim 1, further comprising:
deactivating the cell group; and
while the cell group is deactivated:
performing a link monitoring on the cell group; and
detecting the failure on the cell group based on the link monitoring,
wherein the initiating of the transmission of the failure information comprises while the SCG is deactivated, initiating the transmission of the failure information for the cell group based on detecting the failure on the cell group.

8. The method of claim 7, wherein the link monitoring comprises at least one of a radio link monitoring (RLM) or a beam failure detection (BFD), and
wherein the failure comprises at least one of a radio link failure (RLF) related to the RLM or a beam failure (BF) related to the BFD.

9. The method of claim 7, further comprising:
activating the cell group without performing a random access to the cell group, while the TA timer is running after restarting the TA timer.

10. The method of claim 9, wherein the activating of the cell group without performing a random access to the cell group comprises performing a random access channel (RACH)-less activation of the cell group based on at least one of conditions being met, and
wherein the conditions comprise:
a condition that a radio link failure (RLF) is not detected or RLF is recovered:
a condition that a beam failure (BF) is not detected or BF is recovered:
a condition that the TA timer does not expire or is running; and
a condition that an indication to perform the RACH-less activation is received from a network.

11. The method of claim 7, further comprising:
activating the cell group by performing a random access to the cell group, after the TA timer expires.

12. The method of claim 1, wherein the cell group comprises a secondary cell group (SCG) including a primary secondary cell (PSCell).

13. The method of claim 1, wherein the UE is in communication with at least one of a mobile device, a network, or autonomous vehicles other than the UE.

14. A user equipment (UE) adapted to operate in a wireless communication system, the UE comprising:
at least one transceiver:
at least processor; and
at least one computer memory operably connectable to the at least one processor and storing instructions that, based on being executed by the at least one processor, perform operations comprising:
receiving a time alignment (TA) configuration:
starting a TA timer related to the TA configuration for a cell group:
initiating a transmission of failure information for the cell group based on detecting a failure on the cell group, wherein the TA timer for the cell group expires based on the transmission of the failure information being initiated;
transmitting the failure information for the cell group:
receiving a configuration for failure recovery of the failure on the cell group after transmitting the failure information; and
restarting the TA timer related to the TA configuration for the cell group based on receiving the configuration for failure recovery.

15. A network node adapted to operate in a wireless communication system, the network node comprising:
at least one transceiver:
at least processor; and
at least one computer memory operably connectable to the at least one processor and storing instructions that, based on being executed by the at least one processor, perform operations comprising:
transmitting, to a user equipment (UE), a time alignment (TA) configuration;
receiving, from the UE, failure information for a cell group on which a failure is detected; and
transmitting, to the UE, a configuration for failure recovery of the failure on the cell group after receiving the failure information,
wherein a TA timer related to the TA configuration for the cell group expires based on a transmission of the failure information being initiated by the UE, and
wherein the TA timer related to the TA configuration for the cell group is restarted based on the configuration for failure recovery being received by the UE.

16-18. (canceled)
